(19) United States
(12) Patent Application Publication
(10) Pub. No.: US 2023/0055800 A1
(43) Pub. Date: Feb. 23, 2023

(54) INFORMATION GENERATION METHOD

(71) Applicant: NEC Corporation, Minato-ku , Tokyo (JP)

(72) Inventors: Takuya HISAMOTO, Tokyo (JP); Osamu Tashiro, Tokyo (JP); Makoto Kawai, Tokyo (JP); Taizo Higuchi, Tokyo (JP); Rika Shimizu, Tokyo (JP)

(73) Assignee: NEC Corporation, Minato-ku, Tokyo (JP)

(21) Appl. No.: 17/789,828

(22) PCT Filed: Jan. 15, 2020
(86) PCT No.: PCT/JP2020/001117

§ 371 Date: Jun. 29, 2022

(51) Int. Cl. G01C 21/34; G06Q 10/02

(52) U.S. Cl. CPC G01C 21/343; G06Q 10/025

(57) ABSTRACT

An information generation system according to the present invention includes: an acquiring unit configured to acquire activity place information representing a preset activity place of a user and user information representing a characteristic of the user; and a generating unit configured to generate, based on area information including target information representing an activity target which can be a target for an activity by the user in a predetermined area and based on the activity place information and the user information, activity plan information representing a new activity plan of the user including the target information corresponding to the user information.

### TECHNICAL FIELD

The present invention relates to an information generation method for generating information representing a user's activity plan, an information generating system, and a program.

### BACKGROUND ART

When a user visits a certain area for traveling, sightseeing, a business trip and other purposes, the user can decide an activity with reference to information provision media such as a guidebook, a brochure, a signboard and a website. Also, an area such as a sightseeing spot provides information on a website, a brochure and the like in order to encourage a user's activity in the area.

In particular, in recent years, with the spread of a mobile information processing device such as a smartphone, the user often searches for information of an area by mobile information processing device and decides an activity in the area. For example, the user searches for a place such as a tourist spot and a restaurant where the user can go and stay in consideration of the current location and spare time and decides an activity.

On the other hand, in a case where the user decides an activity destination by himself/herself, the user needs to search for a place such as a tourist spot and a restaurant, and there may be a case where the user cannot retrieve a place as he/she desires. In particular, in a case where the user has unexpected free time, it is difficult to search for a place as the user desires in a short time.

As a technique for solving the problem as mentioned above, Patent Document 1 discloses a navigation device that provides a user with a list of stop-off facilities. Specifically, in Patent Document 1, a route is generated based on a user's schedule, and a list of stop-off facilities which the user can stop off when there is time to spare is displayed. Then, when the user selects a stop-off facility from the list of stop-off facilities, the navigation device generates a route including the selected stop-off facility as a waypoint.

Patent Document 1: Japanese Unexamined Patent Application Publication No. JP-A 2003-302240

However, the technique of Patent Document 1 described above only presents a destination based on a user's schedule, and there is a case where a facility as the user desires is not presented. As a result, there is a possibility that it does not lead to an actual activity by the user, and there arises a problem that information useful for the user is not provided and area revitalization cannot be achieved.

### SUMMARY

Accordingly, an object of the present invention is to provide an information generation method, an information generation system and a program which can solve the abovementioned problem that information useful for the user is not provided and area revitalization cannot be achieved.

An information generation method as an aspect of the present invention includes: acquiring activity place information representing a preset activity place of a user and user information representing a characteristic of the user; and generating, based on area information including target information representing an activity target which can be a target for an activity by the user in a predetermined area and based on the activity place information and the user information, activity plan information representing a new activity plan of the user including the target information corresponding to the user information.

Further, an information generation system as an aspect of the present invention includes: an acquiring unit configured to acquire activity place information representing a preset activity place of a user and user information representing a characteristic of the user; and a generating unit configured to generate, based on area information including target information representing an activity target which can be a target for an activity by the user in a predetermined area and based on the activity place information and the user information, activity plan information representing a new activity plan of the user including the target information corresponding to the user information.

Further, a program as an aspect of the present invention is a computer program including instructions for causing an information processing apparatus to realize: an acquiring unit configured to acquire activity place information representing a preset activity place of a user and user information representing a characteristic of the user; and a generating unit configured to generate, based on area information including target information representing an activity target which can be a target for an activity by the user in a predetermined area and based on the activity place information and the user information, activity plan information representing a new activity plan of the user including the target information corresponding to the user information.

With the configurations as described above, the present invention can provide useful information for the user and can achieve area revitalization.

### BRIEF DESCRIPTION OF DRAWINGS

FIG. 1 is a block diagram showing an overall configuration of an information provision system in a first example embodiment of the present invention;

FIG. 2 is a block diagram showing a configuration of an information generation apparatus disclosed in FIG. 1;

FIG. 3 is a view showing an example of information stored in the information generation apparatus disclosed in FIG. 1;

FIG. 4 is a view showing an example of information stored in the information generation apparatus disclosed in FIG. 1;

FIG. 5 is a view showing an example of information displayed on a user device disclosed in FIG. 1;

FIG. 6 is a view showing an example of information displayed on the user device disclosed in FIG. 1;

FIG. 7 is a view showing an example of information displayed on the user device disclosed in FIG. 1;

FIG. 8 is a view showing an example of information displayed on the user device disclosed in FIG. 1;

FIG. 9 is a view showing an example of information displayed on the user device disclosed in FIG. 1;

FIG. 10 is a view showing an example of the content of activity plan information generated by the information generation apparatus disclosed in FIG. 1;

FIG. 11 is a view showing an example of the content of activity plan information generated by the information generation apparatus disclosed in FIG. 1;

FIG. 12 is a flowchart showing an operation of the information generation apparatus disclosed in FIG. 1;

FIG. 13 is a flowchart showing an operation of the information generation apparatus disclosed in FIG. 1;

FIG. 14 is a flowchart showing an operation of the information generation apparatus disclosed in FIG. 1;

FIG. 15 is a block diagram showing a hardware configuration of an information generation system in a second example embodiment of the present invention;

FIG. 16 is a block diagram showing a configuration of the information generation system in the second example embodiment of the present invention; and

FIG. 17 is a flowchart showing an operation of the information generation system in the second example embodiment of the present invention.

### EXAMPLE EMBODIMENTS

### First Example Embodiment

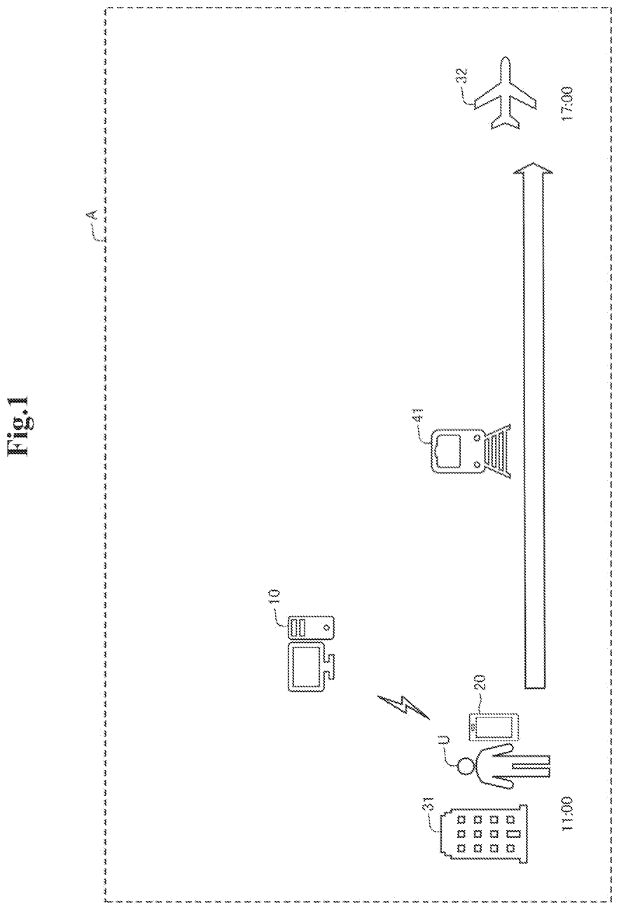

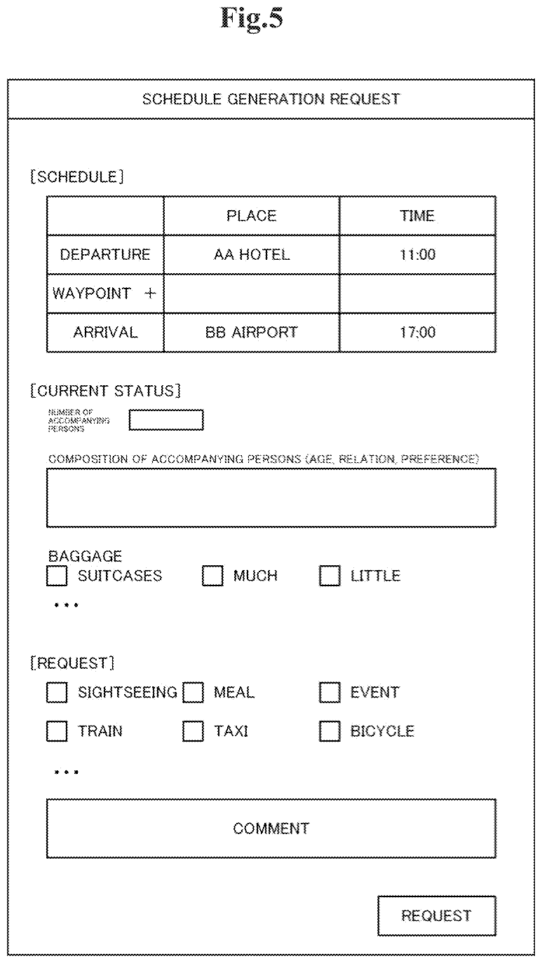

A first example embodiment of the present invention will be described with reference to FIGS. 1 to 14. FIGS. 1 to 4 are views for describing a configuration of an information provision system, and FIGS. 5 to 14 are views for describing a processing operation of the information provision system.

### [Configuration]

The information provision system according to the present invention is for providing a user U visiting a predetermined area such as a sightseeing area with an activity schedule (activity plan information) representing an activity plan. The information provision system includes an information generation apparatus 10 generating an activity schedule provided for the user U as shown in FIG. 1. Moreover, the information generation apparatus 10 is connected to a user device 20 that is a mobile information processing device such as a smartphone owned by the user U via a network. The user U is not necessarily limited to a person visiting a predetermined area for sightseeing but may be any person such as a resident in and around the area.

In this example embodiment, as shown in FIG. 1, the user U is located in a predetermined area A, and the user U has a schedule set in advance and plans to depart from a hotel 31 in the area A at “11:00” and arrive at an airport 32 at “17:00” by using a train 41. Then, the user U desires to visit a visit place such as a sightseeing spot and a restaurant in the area A and travel by using a traveling means such as a bus and a bicycle during the time from “11:00” to “17:00”, and requests the information generation apparatus 10 to generate a new activity schedule. Hereinafter, the respective components will be described in detail.

The user device 20 is a mobile information processing device operated by the user U. The user device 20 has a function to access the information generation apparatus 10 via the network, and can use an activity schedule provision service provided by the information generation apparatus 10. In this example embodiment, for example, the user device 20 has an application for accessing the information generation apparatus 10 installed, and can access the information generation apparatus 10 by using the application and use the activity schedule provision service.

Further, the user device 20 has, as a function by the above application, a function to access the information generation apparatus 10 and perform registration for using the activity schedule provision service. At the time, the user device 20 registers user information representing the characteristic of the user U and activity place information representing the activity place of the user U set in advance. For example, the user U inputs attribute information representing a user attribute such as the gender, age, occupation and preference (preference information) of the user U as the user information into the user device 20 and registers the attribute information into the information generation apparatus 10. Moreover, the user U also registers, as the user information, information such as an area where the user U wants to be provided with a service, a language to use, and whether or not to receive a push notification from the information generation apparatus 10.

Further, the user device 20 has, as a function by the application, a function to register the user information and the activity place information into the information generation apparatus 10 not only at the time of registration described above but also at the time of use of the activity schedule provision service. For example, the user U inputs a departure place and an arrival place and the time to be located at each place (departure time and arrival time) of the user U determined in advance as the activity place information into a “schedule” field of a schedule generation request screen as shown in FIG. 5 displayed on the user device 20 by the application, and registers into the information generation apparatus 10. At the time, the user U may input and register a waypoint and the time to be located at the waypoint. Moreover, the user U inputs activity status information representing a status when service provision is requested, that is, when the user U acts as the user information into a “current status” field of the schedule generation request screen, and registers into the information generation apparatus 10. For example, the activity status information includes the composition of accompanying persons who act together with the user U (the number of the accompanying persons, the relation between the accompanying persons and the user U, and the gender, age and preference of each of the accompanying persons) and the status of the baggage of the user U and the accompanying persons (for example, whether there are suitcases or not, and the amount of the baggage). The user U may input the preference in activity of the user U, for example, the content of activity that the user desires (a visit destination (for sightseeing, meal, event, and other purposes), and a traveling means (train, taxi, bicycle, walking, and the like)) as the user information into a “request” field of the schedule generation request screen, and register into the information generation apparatus 10. At the time, the user U may input the purpose and content of activity that the user desires as activity preference into a “comment” field by using any words and register into the information generation apparatus 10. For example, the user U may input the purpose of activity and content of activity in spare time that the user desires such as “want to relax” and “want to actively play” as the action preference.

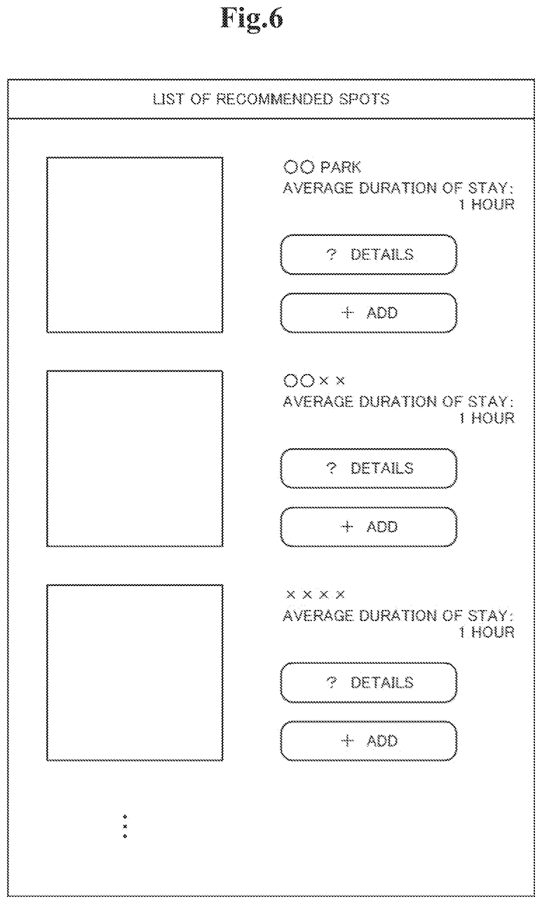

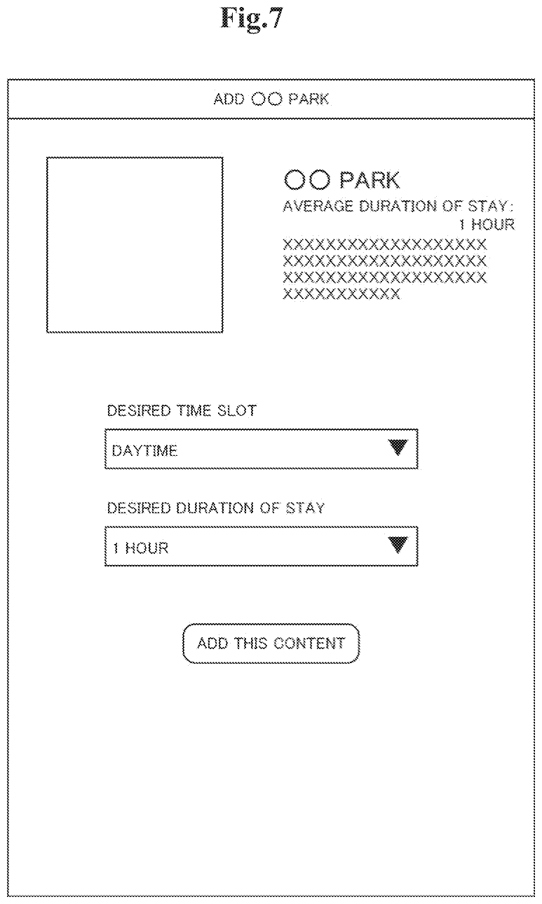

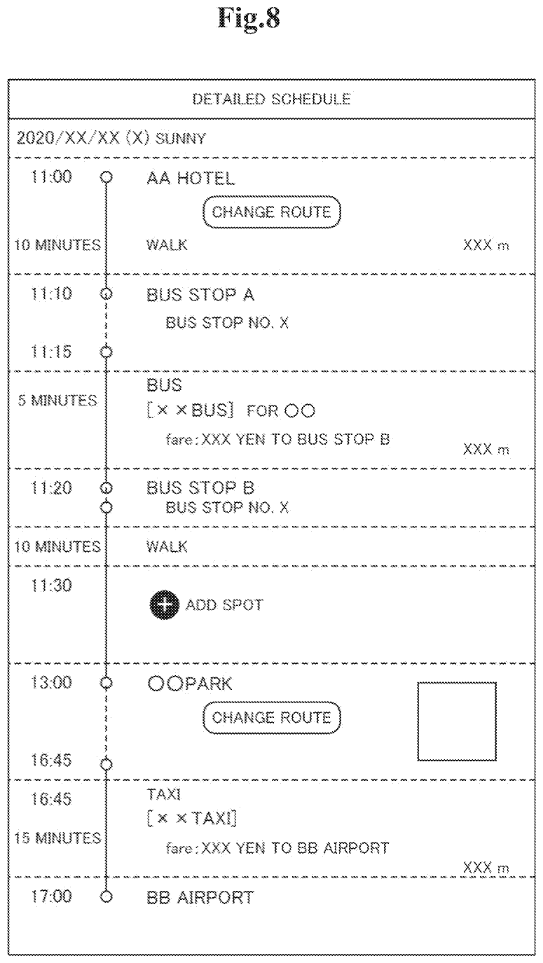

Further, the user device 20 has a function to, by using the application, display information transmitted from the information generation apparatus 10 and transmit various requests input in response to the displayed information to the information generation apparatus 10. For example, as shown in FIG. 6, the user device 20 displays a list of spots such as sightseeing spots transmitted from the information generation apparatus 10, and requests detailed information of each of the spots or makes a request to add a selected one of the spots to an activity schedule. Moreover, as shown in FIG. 7, the user device 20 displays the details of the selected spot transmitted from the information generation apparatus 10, and requests a desired time slot and a desired duration of stay input by the user U. Moreover, as shown in FIG. 8, the user device 20 displays an activity schedule transmitted from the information generation apparatus 10 and, in a case where there is another spot to be added, requests that.

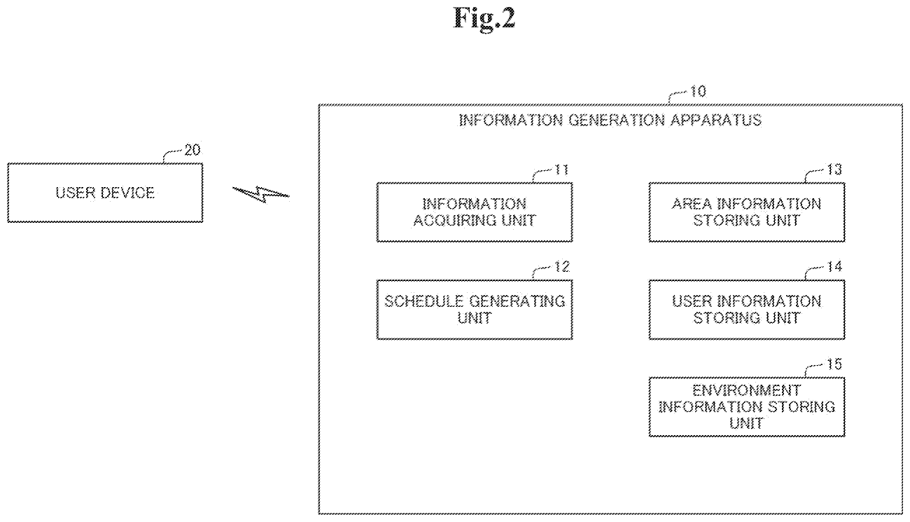

Next, a configuration of the information generation apparatus 10 will be described. The information generation apparatus 10 is configured by one or a plurality of information processing apparatuses including an arithmetic logic unit and a storage unit. As shown in FIG. 2, the information generation apparatus 10 includes an information acquiring unit 11 and a schedule generating unit 12 that are structured by execution of a program by the arithmetic logic unit. The information generation apparatus 10 also includes an area information storing unit 13, a user information storing unit 14, and an environment information storing unit 15 that are formed in the storage unit.

The information acquiring unit 11 (an acquiring unit) first acquires area information that is information on an area A and stores the area information into the area information storing unit 13. The area information first includes map information of the area A. The map information is, for example, information provided by a predetermined business operator that generates map information, and includes information such as topography, the location of roads, and the location of predetermined places such as sightseeing spots and shops. The information acquiring unit 11 downloads and acquires the map information from a web server set up on the Internet or reads and acquires from a storage medium at any timing, and stores the map information into the area information storing unit 13.

Further, the area information includes target information representing an activity target that can be the target for a user's activity in the area A. The target information is, for example, information of a “visit place” (activity target) such as a sightseeing spot, a shop and an event venue to be a target visited by the user U, or information of a “traveling means” (activity target) such as a train, a bus, a taxi and a rental bicycle to a target used by the user U at the time of traveling.

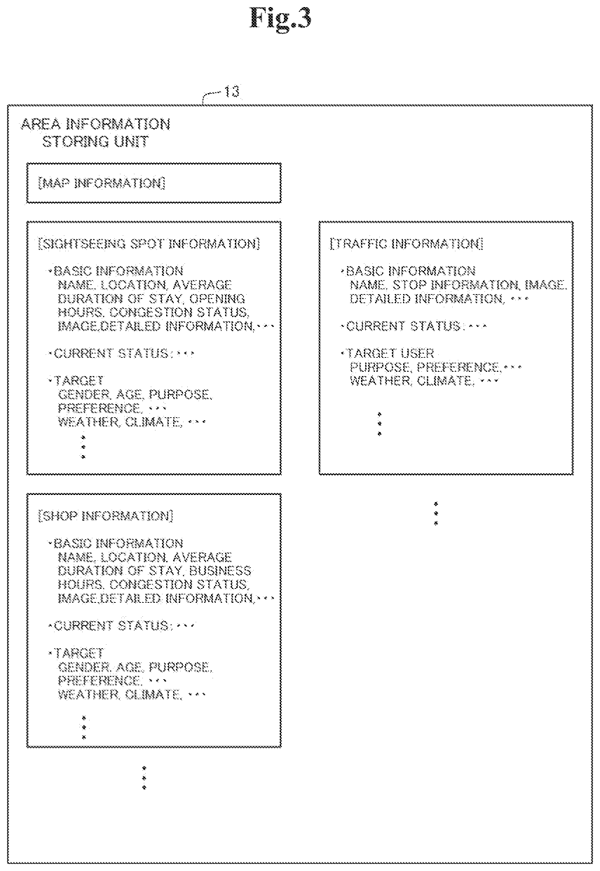

As shown in FIG. 3, information of “visit place” described above includes “sightseeing spot information” and “shop information” as an example, and information of “traveling means” described above includes “traffic information” as an example. These information are information provided by a business operator that operates a visit place such as a sightseeing spot and a shop and a traveling means, and information input by a business operator that operates the information generation apparatus 10 and provides an activity schedule provision service. Therefore, the information acquiring unit 11, at any timing, downloads and acquires the abovementioned target information from a web server set up on the Internet, acquires information transmitted from a device of each business operator, or acquires information input from an operator of the information generation apparatus 10, and stores the information into the area information storing unit 13.

Specifically, as shown in FIG. 3, “sightseeing spot information” and “shop information” include, as “basic information”, information indicating name, location, average duration of stay, opening (business) hours, congestion status, image, and detailed information (explanation, and the like). Moreover, “sightseeing spot information” and “shop information” include “current status” that is information indicating the current congestion status of a sightseeing spot and a shop. Moreover, “sightseeing spot information” and “shop information” include information indicating a user's characteristic and an environment that are the “target” of the sightseeing spot and the shop. That is to say, the “target” fields of “sightseeing spot information” and “shop information” contain information of a user's characteristic such as the age group and preference of a user and the number of accompanying persons suitable for the corresponding sightseeing spot and shop and an environment such as season and weather suitable for visit and use.

As a more specific example, in the case of a sightseeing spot that is often visited by the elderly and preferred by the elderly, the “target” field of “sightseeing spot information” contains information of “age” equivalent to the elderly as a target user characteristic, and in the case of a sightseeing spot that is a historical building, the “target” field of “sightseeing spot information” contains information of preference “historical building” as a target user characteristic. Moreover, as an example, in the case of an outdoor sightseeing spot, the “target” field of “sightseeing spot information” contains information of season and weather that gives a good view as a target environment. Moreover, in the case of a shop that offers dishes preferred by young people, the “target” field of “shop information” contains information of “age” equivalent to young people as a target user characteristic, and contains information of “category” representing corresponding preference as a target user characteristic depending on the category of the dishes provided by the shop. Furthermore, as an example, in a case where the number of persons who can enter the shop at one time is limited or in a case where the number of large baggage such as suitcases that can be brought in is limited, the “target” field of “shop information” contains information such as the number of accompanying persons and whether or not the baggage can be brought in. The abovementioned information contained in the “target” field of “sightseeing spot information” and “shop information” is an example, and other information such as information indicating a user characteristic and environment information that are different from the above may be contained.

Further, specifically, as shown in FIG. 3, “traffic information” described above includes, as “basic information”, information indicating the name, stop position (station, bus stop, parking space of a rental bicycle), image, and detailed information (explanation, and the like) of a traveling means such as a train, a bus, a taxi and a rental bicycle. Moreover, “traffic information” includes “current status” that is information indicating a status such as the congestion status of a traveling means. Moreover, “traffic information” includes information indicating a user characteristic and an environment to be “target” of the traveling means. That is to say, the “target” field of “traffic information” contains user characteristics such as the age group and preference of the user suitable for the corresponding traveling means and the number of persons using at a time, and information of environment such as season and weather.

As a more specific example, in a case where a traveling means is a taxi, the “target” field of “traffic information” contains information of “age” equivalent to the elderly as a target user characteristic, and in a case where a traveling means is a rental bicycle, the “target” field of “traffic information” contains information of “cycling” indicating corresponding preference as a target user characteristic. Moreover, as an example, in a case where a traveling means is a train or a bus, the “target” field of “traffic information” contains information of season and weather that does not make it difficult to move outdoors as the target environment.

Further, the information acquiring unit 11 acquires registered user information that is information on the user U registered to use the activity schedule provision service, and stores into the user information storing unit 14. For example, in accordance with a registration request or a service provision request transmitted by operation of an application installed in the user device 20 by the user U, the information acquiring unit 11 transmits an information input screen to the user device 20, acquires information input on the input screen, and stores into the user information storing unit 14.

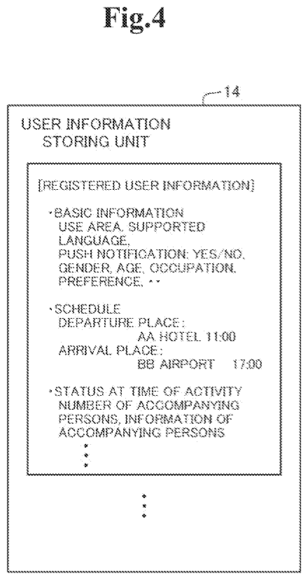

The registered user information includes, as described above, user information representing the characteristic of the user U transmitted from the user device 20 at the time of registration or at the time of requesting service provision, and activity place information representing the activity place of the user U set in advance. For example, as shown in FIG. 4, the registered user information includes, as “basic information”, user information representing the characteristic of the user U such as a use area, a supported language, the presence or absence of push notification, and attribute information representing user attributes including gender, age, occupation and preference (preference information) of the user U. Moreover, the registered user information includes, as “schedule”, activity place information representing the activity place of the user U set in advance such as a departure place and an arrival place and time to be located in each place of the user U set in advance. Moreover, the registered user information includes, as “activity time status”, user information representing the characteristic of the user U such as the composition of accompanying persons who act together with the user U (the number of the accompanying persons, the relation between the accompanying persons and the user U, the gender, age, preference, and the like of each accompanying person), the status of the baggage of the user U and the accompanying persons (for example, the presence or absence of suitcases, the amount of the baggage, and the like), the content of activity desired by the user at the time of activity (a visit destination (for sightseeing, meal, event, and other purposes), and a traveling means (a train, a taxi, a bicycle, walking, and the like))

Further, the information acquiring unit 11 acquires environment information and stores into the environment information storing unit 15. The environment information includes weather information and season information of the area A, for example, information provided by a predetermined business operator that provides weather information. The information acquiring unit 11 downloads and acquires weather information from a web server set up on the Internet at any timing, or acquires from a preset measurement device such as a sensor, and stores the weather information into the storage unit 15.

The schedule generating unit 12 (a generating unit) generates, upon receiving a service provision request transmitted by operation of an application installed in the user device 20 by the user U, a new activity schedule based on the area information, the registered user information, and the environment information. In a case where “schedule”, “current status”, and “request” of the user U are input on an input screen shown in FIG. 5 at the time of receiving the service provision request from the user device 20, the schedule generating unit 12 requests the information acquiring unit 11 to register the above information into the registered user information of the user U

Then, upon receiving the service provision request from the user device 20, the schedule generating unit 12 extracts, from among “sightseeing spot information”, “shop information” and “traffic information” stored in the area information storing unit 13 as shown in FIG. 3, those corresponding to the registered user information of the user U requesting service provision. At the time, the schedule generating unit 12 first extracts “sightseeing spot information”, “shop information” and “traffic information” that correspond to the user information representing the user characteristics included in “basic information” and “activity time status” of the user U registered as the registered user information and also correspond to the environment information stored in the environment information storing unit 15. Specifically, the schedule generating unit 12 checks whether or not an attribute such as gender, age and preference of the user U included by the registered user information and information representing the current season and weather of the area A match with or correspond to information included in each of the “target” fields of “sightseeing spot information”, “shop information” and “traffic information”, and extracts the matching or corresponding “sightseeing spot information”, “shop information” and “traffic information”. As an example, the schedule generating unit 12 extracts “sightseeing spot information”, “shop information” and “traffic information” in which the “target” fields contain all of “age”, “preference”, “number of accompanying persons” and “weather” in the registered user information. Meanwhile, the schedule generating unit 12 may extract “sightseeing spot information”, “shop information” and “traffic information” in which the “target” fields contain at least one of the information representing the user characteristics included in the registered user information, or may not use the environment information. Moreover, the schedule generating unit 12 is not necessarily limited to extracting “sightseeing spot information”, “shop information” and “traffic information” in which the “target” fields contain the same information as the user information included in the registered user information, but may extract “sightseeing spot information”, “shop information” and “traffic information” in which the “target” fields contain information corresponding to the user information.

Then, the schedule generating unit 12 presents sightseeing spots, shops and traveling means corresponding to the extracted “sightseeing spot information”, “shop information” and “traffic information” on the user device 20. Moreover, the schedule generating unit 12 receives a sightseeing spot, a shop and a traveling means selected by the user U on the user device 20 from among the sightseeing spots, shops and traveling means presented on the user device 20. For example, as shown in FIG. 6, the schedule generating unit 12 displays a list of extracted spots such as sightseeing spots on the user device 20 and, at the time, displays a button for requesting the image, name, average duration of stay and detailed explanation of each spot and a button for requesting addition to the schedule. Moreover, upon receiving a request to add the selected sightseeing spot from the user device 20, as shown in FIG. 7, the schedule generating unit 12 displays detailed information of the sightseeing spot on the user device 20 and, at the time, also displays a field for inputting a time slot when the user U wants to go to the sightseeing spot and a desired duration of stay. Then, the schedule generating unit 12 receives the time slot when the user U wants to go to the sightseeing spot and the desired duration of stay input into the user device 20. Meanwhile, when presenting the list of the extracted spots on the user device 20, the schedule generating unit 12 may present the list after sorting the spots or marking a specific one of the spots. For example, the schedule generating unit 12 may display a spot including a higher rate of information matching the user information (an attribute, and the like) and the environment information in a higher position, or the schedule generating unit 12 may set a weight for each item of the user information (an attribute, and the like) and display a spot including a higher rate of information matching the user information with a higher weight in a higher position or display after marking.

After that, the schedule generating unit 12 specifies the location of the selected sightseeing spot, the desired time slot and the desired duration of stay received from the user device 20, and also specifies the departure place and departure time and the arrival place and arrival time of the user U with reference to “schedule” in the registered user information. Then, the schedule generating unit 12 generates a new activity schedule so that, between the time when the user U departs from the departure place at the departure time and the time when the user U arrives at the arrival place at the arrival time, the user U can go to the selected sightseeing spot in the desired time slot and stay there for the desired duration of stay. At the time, the schedule generating unit 12 selects a traveling means as necessary with reference to the map information, and generates an activity schedule along the time series in consideration of travel time. Meanwhile, the schedule generating unit 12 may select a traveling means in consideration of the user information (for example, the attributes (age, preference, and the like) of the user).

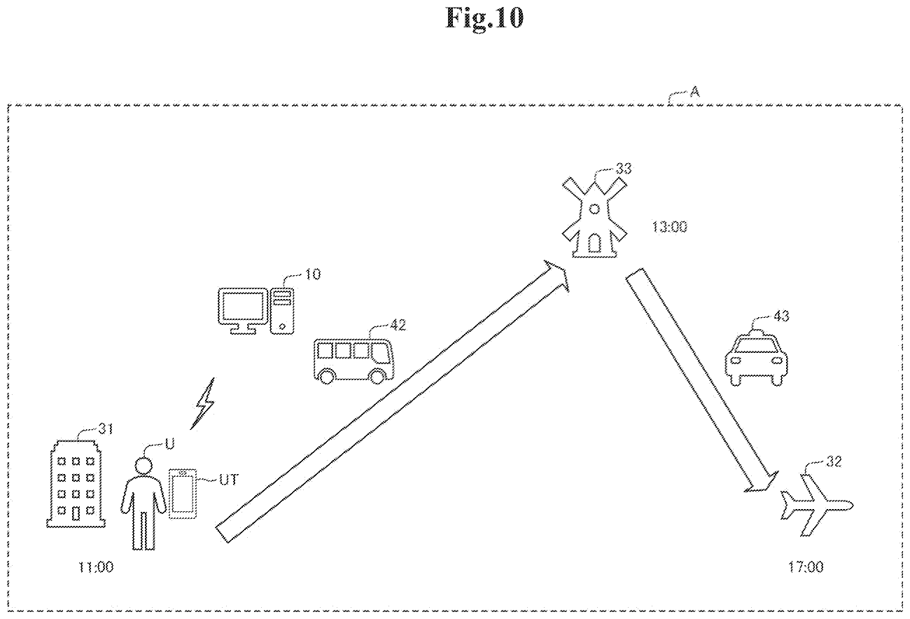

Then, the schedule generating unit 12 provides the generated activity schedule to display on the user device 20 as shown in FIG. 8. As an example, in the generated activity schedule shown in FIG. 8, “○○ park” that is a sightseeing spot extracted in accordance with the characteristic of the user U and then selected by the user U, is incorporated in a time slot from “13:00” to “16:45”. Specifically, as shown in FIG. 8 and FIG. 10, it is scheduled to depart from AA hotel 31 that is the departure place at the departure time “11:00”, travel to a sightseeing spot 33 by foot or by using a bus 42 and, after sightseeing, arrives at an airport 32 that is the arrival place at the arrival time “17:00” by using a taxi 43.

In the above example, “○○ park” is incorporated in the time slot not from “11:30” but from “13:00” to “16:45”. This is because “○○ park” may be crowded in the time slot from “11:30” in consideration of a busy time slot representing the status of the sightseeing spot included in “sightseeing spot information” of “○○ park” and therefore the schedule generating unit 12 generates a schedule by incorporating “○○ park” in the abovementioned time slot. That is to say, in the above example, the schedule generating unit 12 generates an activity schedule in which the busy time slot registered as the status of the selected “○○ park” is avoided.

In a case where, when an activity schedule is generated in the abovementioned manner, the schedule does not allow the user U to arrive at the arrival place at the preset arrival time, the schedule generating unit 12 cancels the sightseeing spot or the like selected by the user U and again requests the user device 20 to select another sightseeing spot or the like. Alternatively, the schedule generating unit 12 may extract other sightseeing spots and the like that are different from the already extracted sightseeing spots and the like based on the user information and the like and present them onto the user device 20 and cause the user U to select from among them again. Thus, the schedule generating unit 12 generates a new activity schedule which allows the user U to act within a preset schedule.

At the time of extraction of a sightseeing spot and the like corresponding to the user information and the like as described above, the schedule generating unit 12 may recognize the departure place and departure time and the arrival place and arrival time of the user U with reference to “activity schedule” in the registered user information in advance, and exclude a sightseeing spot which the user U cannot visit obviously in consideration of the location and average duration of stay of the sightseeing spot from extraction targets.

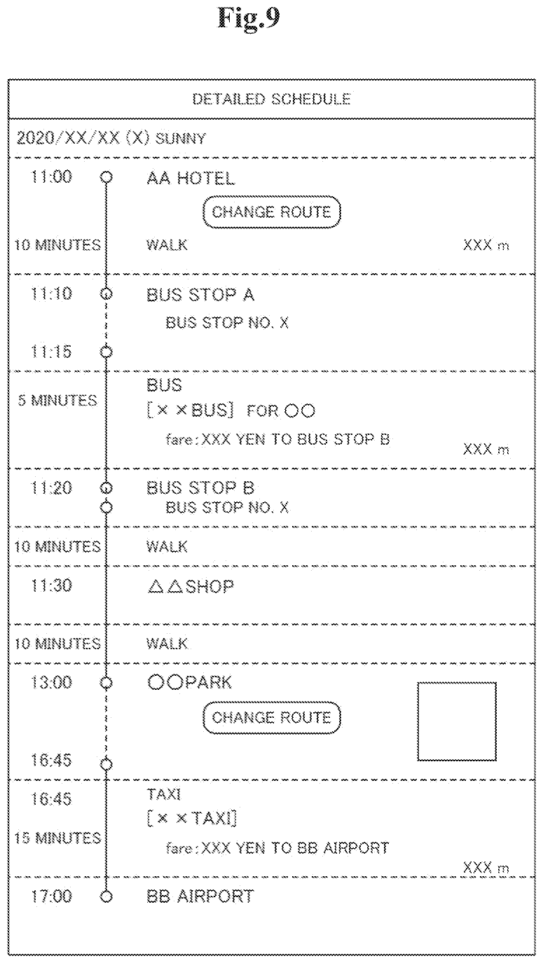

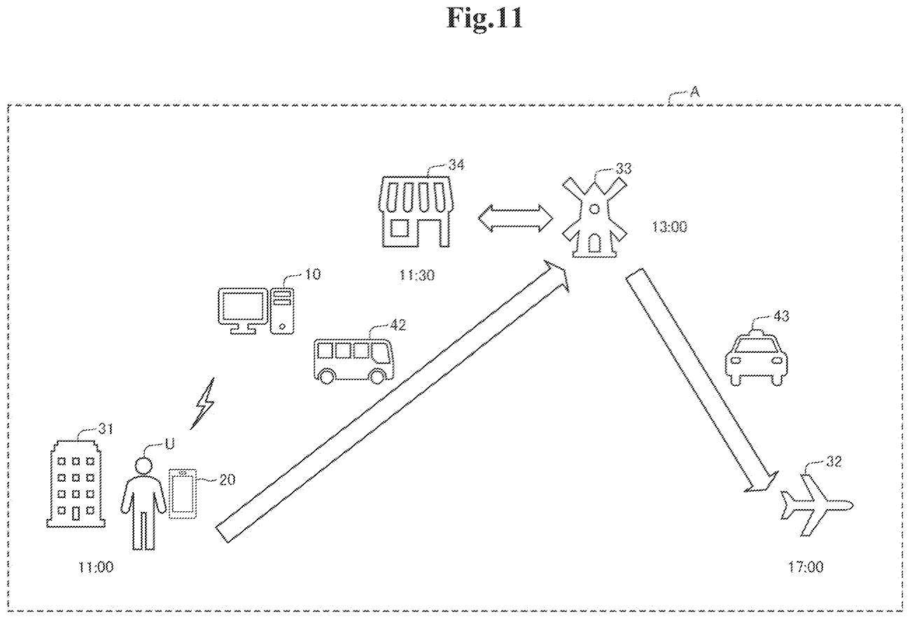

As shown in FIG. 8, the schedule generating unit 12 sets and displays a button for adding a spot into predetermined spare time in the activity schedule. With this, the user U selects the button for adding a spot on the user device 20 and, in the same manner as described above, the schedule generating unit 12 further extracts a sightseeing spot, a shop and the like corresponding to the user information and the like, allows the user U to select, and generate a schedule. For example, as shown in FIG. 9 and FIG. 11, the schedule generating unit 12 can add a visit to a shop 34 at “11:30” and can generate an activity schedule so as to visit the sightseeing spot 33 at “13:00” after that.

Further, in the above description, the schedule generating unit 12 extracts only sightseeing spots corresponding to the user information and the environment information, displays a list of the sightseeing spots on the user device 20, and causes the user U to select from the list as shown in FIG. 6. However, the schedule generating unit 12 may extract and present any activity targets such as shops, events and traveling means in addition to sightseeing spots and cause the user U to select. For example, the schedule generating unit 12 may extract and present only transferring means and cause the user U to select and generate an activity schedule in which only transfer is the target of action.

Further, in the above description, the user U is caused to select a sightseeing spot and the like, but it is not always necessary to cause the user U to select. For example, when only one sightseeing spot and the like corresponding to the user information is extracted, the schedule generating unit 12 may automatically generate an activity schedule including the sightseeing spot and the like. When a plurality of sightseeing spots and the like corresponding to the user information are extracted, the schedule generating unit 12 may automatically generate an activity schedule in which some of the extracted sightseeing sports and the like are incorporated.

Further, in the above description, activity place information that is a preset schedule of the user U includes a departure place, departure time, an arrival place and arrival time, but the activity place information may include information of only a departure place or only an arrival place. In this case, the schedule generating unit 12 generates a schedule including a sightseeing spot and the like which the user U can visit after departing from the departure place, or a schedule that allows the user U to arrive at the arrival place after sightseeing.

In the above description, the user U requests the information generation apparatus 10 to provide an activity schedule via the user device 20 that is a mobile information processing device and receives the activity schedule from the information generation apparatus 10. However, the user U may request the information generation apparatus 10 to provide an activity schedule via, not only a mobile information processing device but also any other information processing device and receive the activity schedule. For example, a digital signage set up on the street or in a predetermined facility may have the function of the user device 20 described above. In this case, the user U performs, on the digital signage, the same operation as the operation performed on the user device 20 described above, and the information generation apparatus 10 may receive the activity schedule generation request from the digital signage, generate the activity schedule, and display on the digital signage.

### [Operation]

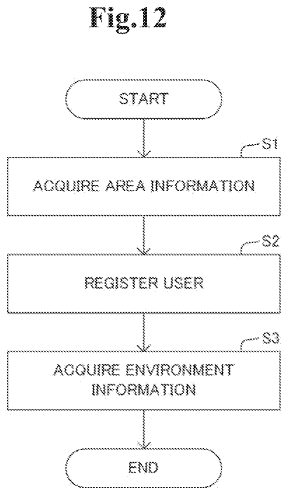

Next, an operation of the above information generation apparatus 10 will be described with reference to flowcharts shown in FIGS. 12 to 14. First, the information generation apparatus 10 acquires and stores area information that is information on an area A (step S1 of FIG. 12). Specifically, the information generation apparatus 10 acquires and stores, as the area information, map information of the area A and target information representing an activity target which can be the target for a user's activity in the area A. The target information includes, for example, as shown in FIG. 3, “sightseeing spot information” and “shop information” that are information of “visit place” such as a sightseeing spot, a shop and an event venue to be a target visited by the user U, and “traffic information” that is information of “traveling means” such as a train, a bus, a taxi and a rental bicycle to be a target used by the user U at the time of traveling.

The information generation apparatus 10 may acquire the above area information at any timing. For example, the information generation apparatus 10 may acquire current statuses included by “sightseeing spot information”, “shop information” and “traveling means” at constant time intervals.

Further, the information generation apparatus 10 acquires and stores registered user information that is information on the user U (step S2 of FIG. 12). Specifically, the information generation apparatus 10 acquires registered user information as shown in FIG. 4 that includes user information representing the characteristic of the user U transmitted in accordance with a registration request from the user device 20 and activity place information representing the activity place of the user U set in advance. The information generation apparatus 10 also acquires the user information and the activity place information transmitted in accordance with a service provision request by the user U described later.

Further, the information generation apparatus 10 acquires and stores environment information (step S3 of FIG. 12). Specifically, the information generation apparatus 10 acquires weather information and season information of the area A as the environment information. The information processing apparatus 10 may acquire the environment information at constant time intervals.

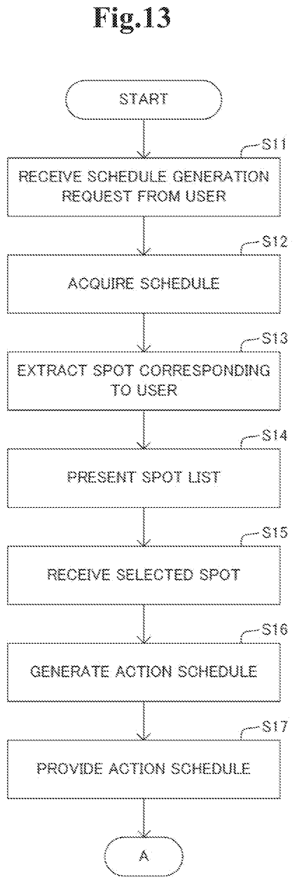

After that, the information processing apparatus 10 receives a service provision request from the user device 20 (step S11 of FIG. 13). At the time, in a case where “schedule”, “current status” and “request” of the user U are input on an input screen at the time of request for service provision as shown in FIG. 5, the information generation apparatus 10 receives the information and registers into the registered user information of the corresponding user U (step S12 of FIG. 13). That is to say, also at the time of request for service provision, the information generation apparatus 10 acquires the user information representing the characteristic of the user U and the activity place information representing the activity place of the user U set in advance. The information generation apparatus 10 may acquire the user information and the activity place information at the time of registration described above, or may acquire at any timing.

Then, the information generation apparatus 10 extracts, from “sightseeing spot information”, “shop information” and “traffic information” stored in the area information storing unit 13, those corresponding to the registered user information of the user U having made the service provision request (step S13 of FIG. 13). At the time, the information generation apparatus 10 extracts, for example, “sightseeing spot information”, “shop information” and “traffic information” in which information corresponding to the attribute and preference of the user U registered in the registered user information is registered. Moreover, the information generation apparatus 10 may narrow the extracted information down to that corresponding to the environment information representing the environment of the area A.

Subsequently, as shown in FIG. 6, the information generation apparatus 10 presents a list of spots such as the extracted “sightseeing spot information” to the user device 20 (step S14 of FIG. 13). Then, the information generation apparatus 10 receives the selection of the presented spots from the user device 20 (step S15 of FIG. 13). At the time, the information generation apparatus 10 further receives a desired time slot to go to the selected spot and a desired duration of stay from the user device 20.

Subsequently, the information generation apparatus 10 generates a new activity schedule (step S16 of FIG. 13). At the time, the information generation apparatus 10 recognizes a departure place, departure time, an arrival place and arrival time of the user U set in advance from the registered user information of the user U, and generates an activity schedule so that the user U can stay in the selected spot as mentioned above during the time from departure from the departure place to arrival at the arrival place. The information generation apparatus 10 selects a traveling means as necessary with reference to the map information, and generates an activity schedule along the time series as shown in FIG. 8 in consideration of a travel time. In the information generation apparatus 10, the schedule generating unit 12 may select a traveling means in consideration of the user information (for example, a user's attribute (age, preference, and the like)).

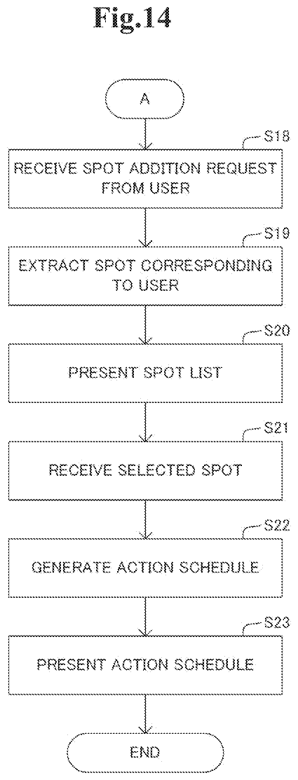

Then, the information generation apparatus 10 presents the new activity schedule having been generated to the user device 20 (step S17 of FIG. 13). At the time, the information generation apparatus 10 sets and displays a button for adding a spot in predetermined spare time in the activity schedule as shown in FIG. 8. Along with this, when the button for adding a spot is selected on the user device 20, the information generation apparatus 10 receives the request (step S18 of FIG. 14), and further extracts a spot corresponding to the user information in the same manner as described above (step S19 of FIG. 14). After that, the information generation apparatus 10 presents a list of the extracted spots in the same manner as described above to the user device 20 (step S20 of FIG. 14), receives a selected spot from the user U (step S21 of FIG. 14), generates a new activity schedule (step S22 of FIG. 14), and presents to the user device 20 (step S23 of FIG. 14). Thus, a new activity schedule as shown in FIG. 9 can be generated.

As described above, the information generation apparatus 10 in this example embodiment can generate an activity schedule including a sightseeing spot, a shop and a traveling means corresponding to the attribute, preference and the like of the user U, and present the activity schedule to the user U. Therefore, the user U can obtain beneficial information such as an activity schedule properly corresponding to himself/herself. As a result, an activity by the user U in an area is encouraged, and it is possible to revitalize the area.

Further, the information generation apparatus 10 in this example embodiment generates an activity schedule including a visit destination and a traveling means in consideration of a status at the time of activity of the user U, such as an accompanying person, and the environment. Therefore, it is possible to further provide information that is more beneficial to the user U, and it is possible to further revitalize the area because an activity by the user U in the area is encouraged.

### Second Example Embodiment

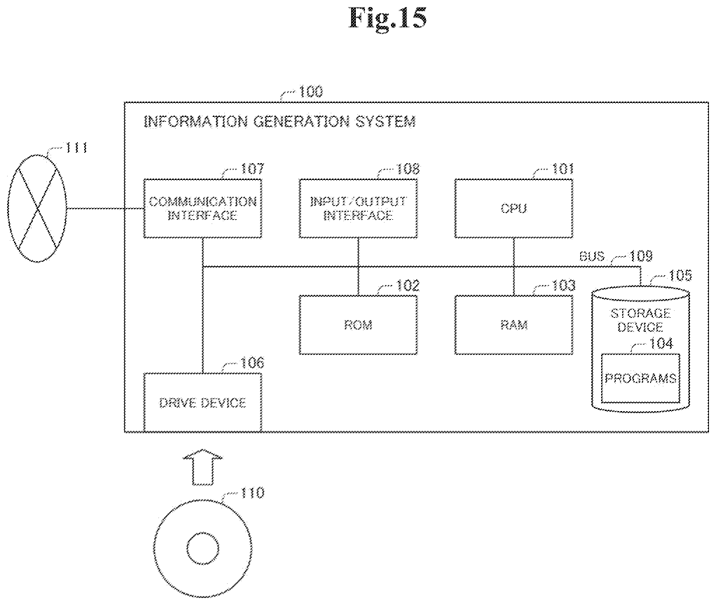

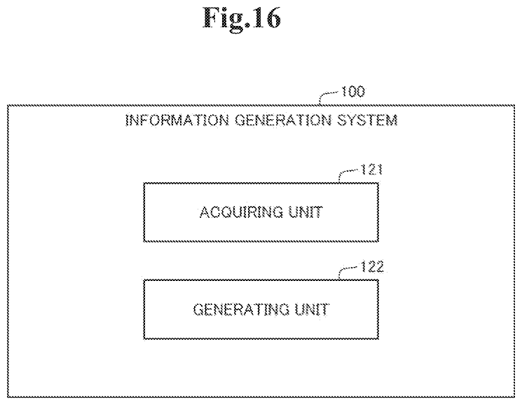

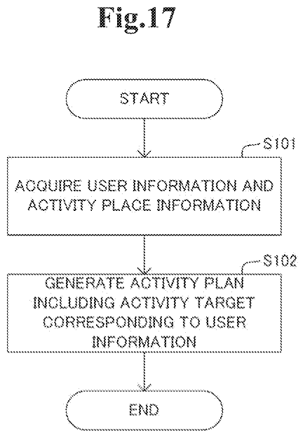

Next, a second example embodiment of the present invention will be described with reference to FIGS. 15 to 17. FIGS. 15 to 16 are block diagrams showing a configuration of an information generation system in the second example embodiment, and FIG. 17 is a flowchart showing an operation of the information generation system. In this example embodiment, the overview of the configurations of the information generation apparatus described in the first example embodiment and an information generation method is shown.

First, a hardware configuration of an information generation system 100 in this example embodiment will be described with reference to FIG. 15. The information generation system 100 is configured by one or a plurality of general information processing apparatuses and, as an example, has a hardware configuration including;

a CPU (Central Processing Unit) 101 (arithmetic logic unit),

a ROM (Read Only Memory) 102 (storage unit),

a RAM (Random Access Memory) 103 (storage unit),

programs 104 loaded to the RAM 103,

a storage device 105 for storing the programs 104,

a drive device 106 that reads from and writes into a storage medium 110 outside the information processing apparatus,

a communication interface 107 connected to a communication network 111 outside the information processing apparatus,

an input/output interface 108 that inputs and outputs data, and

a bus 109 that connects the respective components.

Then, the information generation system 100 can structure and include an acquiring unit 121 and a generating unit 122 shown in FIG. 16 by acquisition and execution of the programs 104 by the CPU 101. The programs 104 are, for example, stored in the storage device 105 or the ROM 102 in advance, and the CPU 101 loads to the RAM 103 and executes as necessary. The programs 104 may be supplied to the CPU 101 via the communication network 111, or the programs 104 may be stored in the storage medium 110 in advance and retrieved by the drive device 106 and supplied to the CPU 101 via the communication network 111. Meanwhile, the acquiring unit 121 and the generating unit 122 mentioned above may be structured by an electronic circuit.

FIG. 15 shows an example of the hardware configuration of the information generation system 100, and the hardware configuration of the information generation system is not limited to the abovementioned case. For example, the information generation system may include part of the abovementioned configuration, for example, excluding the drive device 106.

Then, the information generation system 100 executes an information generation method shown in the flowchart of FIG. 17 by the functions of the acquiring unit 121 and the generating unit 122 structured by the program as described above.

As shown in FIG. 17, the information generation system 100 acquires activity place information representing a preset activity place of a user and user information representing a characteristic of the user (step S101) and, based on area information including target information representing an activity target which may be a target for an activity by the user in a predetermined area, and the activity place information and the user information, generates activity plan information representing a new activity plan of the user including the target information corresponding to the user information (step S102).

With the configuration as described above, this example embodiment allows generation of an activity schedule including an activity target corresponding to the characteristic of a user. Therefore, it is possible to generate and present an activity schedule which is beneficial to the user, and consequently, an activity in an area by the user is encouraged and revitalization of the area can be achieved.

### Supplementary Notes

The whole or part of the example embodiments disclosed above can be described as the following supplementary notes. Below, the overview of the configurations of an information generation method, an information generation system, and a program according to the present invention will be described. However, the present invention is not limited to the following configurations

### (Supplementary Note 1)

An information generation method comprising:

acquiring activity place information representing a preset activity place of a user and user information representing a characteristic of the user; and

generating, based on area information including target information representing an activity target which can be a target for an activity by the user in a predetermined area and based on the activity place information and the user information, activity plan information representing a new activity plan of the user including the target information corresponding to the user information.

### (Supplementary Note 2)

The information generation method according to Supplementary Note 1,wherein the target information includes information of a preset visit place and/or traveling unit in the predetermined area,

the information generation method comprising

generating the activity plan information including the information of the visit place and/or traveling unit corresponding to the user information based on the area information and the activity place information.

### (Supplementary Note 3)

The information generation method according to Supplementary Note 1 or 2, wherein the user information includes attribute information representing an attribute of the user,

the information generation method comprising

generating the activity plan information including the target information corresponding to the attribute information based on the area information and the activity place information.

### (Supplementary Note 4)

The information generation method according to Supplementary Note 3, wherein the attribute information includes preference information representing preference of the user,

the information generation method comprising

generating the activity plan information including the target information corresponding to the preference information based on the area information and the activity place information.

### (Supplementary Note 5)

The information generation method according to any of Supplementary Notes 1 to 4, wherein the user information includes activity status information representing a status at time of activity of the user,

the information generation method comprising

generating the activity plan information including the target information corresponding to the activity status information based on the area information and the activity place information.

### (Supplementary Note 6)

The information generation method according to any of Supplementary Notes 1 to 5, wherein the area information further includes environment information representing an environment in the predetermined area,

the information generation method comprising

generating the activity plan information including the target information corresponding to the user information and the environment information based on the area information and the activity place information.

### (Supplementary Note 7)

The information generation method according to any of Supplementary Notes 1 to 6, wherein the target information further includes information representing a status of the target corresponding to the target information,

the information generation method comprising

generating the activity plan information including the target information corresponding to the user information based on the area information and the activity place information.

### (Supplementary Note 8)

The information generation method according to any of Supplementary Notes 1 to 7, wherein the activity place information includes time at which the user should be located in the activity place,

the information generation method comprising

generating the activity plan information including the target information representing the target in which the user can act based on the area information and the activity place information.

### (Supplementary Note 9)

The information generation method according to Supplementary Note 8, wherein the activity place information includes time to be located in a preset departure place and time to be located in a preset arrival place, the departure place and the arrival place being the activity places of the user,

the information generation method comprising

generating, based on the area information and the activity place information, the activity plan information including the target information representing the target that allows the user to depart from the departure place at the time to be located in the departure place and arrive at the arrival place at the time to be located at the arrival place and allows the user to act during time between when the user departs from the departure place and when the user arrives at the arrival place.

### (Supplementary Note 10)

The information generation method according to Supplementary Note 8 or 9, comprising

generating the activity plan information including the target information representing the target in which the user can stay for a preset duration or more based on the area information and the activity place information.

### (Supplementary Note 11)

The information generation method according to any of Supplementary Notes 1 to 10, comprising

presenting the target information to the user and also receiving selection of the target information from the user, and generating the activity plan information including the selected target information.

### (Supplementary Note 12)

The information generation method according to any of Supplementary Notes 1 to 11, comprising

generating the activity plan information including time at which the user should be located in the activity place and time at which the user acts in the target corresponding to the target information.

### (Supplementary Note 13)

An information generation system comprising:

an acquiring unit configured to acquire activity place information representing a preset activity place of a user and user information representing a characteristic of the user; and

a generating unit configured to generate, based on area information including target information representing an activity target which can be a target for an activity by the user in a predetermined area and based on the activity place information and the user information, activity plan information representing a new activity plan of the user including the target information corresponding to the user information.

### (Supplementary Note 14)

The information generation system according to Supplementary Note 13, wherein:

the target information includes information of a preset visit place and/or traveling unit in the predetermined area; and

the generating unit is configured to generate the activity plan information including the information of the visit place and/or traveling unit corresponding to the user information based on the area information and the activity place information.

### (Supplementary Note 15)

The information generation system according to Supplementary Note 13 or 14, wherein:

the user information includes attribute information representing an attribute of the user; and

the generating unit is configured to generate the activity plan information including the target information corresponding to the attribute information based on the area information and the activity place information.

### (Supplementary Note 16)

The information generation system according to Supplementary Note 15, wherein:

the attribute information includes preference information representing preference of the user; and

the generating unit is configured to generate the activity plan information including the target information corresponding to the preference information based on the area information and the activity place information.

### (Supplementary Note 17)

The information generation system according to any of Supplementary Notes 13 to 16, wherein:

the user information includes activity status information representing a status at time of activity of the user; and

the generating unit is configured to generate the activity plan information including the target information corresponding to the activity status information based on the area information and the activity place information.

### (Supplementary Note 18)

The information generation system according to any of Supplementary Notes 13 to 17, wherein:

the area information further includes environment information representing an environment in the predetermined area; and

the generating unit is configured to generate the activity plan information including the target information corresponding to the user information and the environment information based on the area information and the activity place information.

### (Supplementary Note 19)

The information generation system according to any of Supplementary Notes 13 to 18, wherein:

the target information further includes information representing a status of the target corresponding to the target information; and

the generating unit is configured to generate the activity plan information including the target information corresponding to the user information based on the area information and the activity place information.

### (Supplementary Note 20)

The information generation system according to any of Supplementary Notes 13 to 19, wherein:

the activity place information includes time at which the user should be located in the activity place; and

the generating unit is configured to generate the activity plan information including the target information representing the target in which the user can act based on the area information and the activity place information.

### (Supplementary Note 21)

The information generation system according to Supplementary Note 20, wherein:

the activity place information includes time to be located in a preset departure place and time to be located in a preset arrival place, the departure place and the arrival place being the activity places of the user; and

the generating unit is configured to generate, based on the area information and the activity place information, the activity plan information including the target information representing the target that allows the user to depart from the departure place at the time to be located in the departure place and arrive at the arrival place at the time to be located at the arrival place and allows the user to act during time between when the user departs from the departure place and when the user arrives at the arrival place.

### (Supplementary Note 22)

The information generation system according to Supplementary Note 20 or 21, wherein

the generating unit is configured to generate the activity plan information including the target information representing the target in which the user can stay for a preset duration or more based on the area information and the activity place information.

### (Supplementary Note 23)

The information generation system according to any of Supplementary Notes 13 to 22, wherein

the generating unit is configured to present the target information to the user and also receive selection of the target information from the user, and generate the activity plan information including the selected target information.

### (Supplementary Note 24)

The information generation system according to any of Supplementary Notes 13 to 23, wherein

the generating unit is configured to generate the activity plan information including time at which the user should be located in the activity place and time at which the user acts in the target corresponding to the target information.

### (Supplementary Note 25)

A computer program comprising instructions for causing an information processing apparatus to realize:

an acquiring unit configured to acquire activity place information representing a preset activity place of a user and user information representing a characteristic of the user; and

a generating unit configured to generate, based on area information including target information representing an activity target which can be a target for an activity by the user in a predetermined area and based on the activity place information and the user information, activity plan information representing a new activity plan of the user including the target information corresponding to the user information.

The above program can be stored by using various types of non-transitory computer-readable mediums and supplied to a computer. The non-transitory computer-readable mediums include various types of tangible storage mediums. Examples of the non-transitory computer-readable mediums are a magnetic recording medium (for example, a flexible disk, a magnetic tape, a hard disk drive), a magnetooptical recording medium (for example, a magnetooptical disk), a CD-ROM (Read Only Memory), a CD-R, a CD-R/W, and a semiconductor memory (for example, a mask ROM, a PROM (Programmable ROM), an EPRON (Erasable PROM), a flash ROM, a RAM (Random Access Memory)). Moreover, the program may be supplied to a computer by various types of transitory computer-readable mediums. Examples of the transitory computer-readable mediums include an electric signal, an optical signal, and an electromagnetic wave. The transitory computer-readable mediums can supply the program to a computer via a wired communication path such as an electric wire and an optical fiber or via a wireless communication path.

Although the present invention has been described above with reference to the example embodiments, the present invention is not limited to the above example embodiments. The configurations and details of the present invention can be changed in various manners that can be understood by one skilled in the art within the scope of the present invention.

### DESCRIPTION OF NUMERALS

10 information generating apparatus
11 information acquiring unit
12 schedule generating unit
13 area information storing unit
14 user information storing unit
15 environment information storing unit
20 user device
100 information generation system

### 101 CPU

### 102 ROM

### 103 RAM

104 programs
105 storage device
106 drive device
107 communication interface
108 input/output interface
109 bus
110 storage medium
111 communication network
121 acquiring unit
122 generating unit

1. An information generation method comprising:
acquiring activity place information representing a preset activity place of a user and user information representing a characteristic of the user; and
generating, based on area information including target information representing an activity target which can be a target for an activity by the user in a predetermined area and based on the activity place information and the user information, activity plan information representing a new activity plan of the user including the target information corresponding to the user information.

2. The information generation method according to claim 1, wherein the target information includes information of a preset visit place and/or traveling unit in the predetermined area,
the information generation method comprising
generating the activity plan information including the information of the visit place and/or traveling unit corresponding to the user information based on the area information and the activity place information.

3. The information generation method according to claim 1, wherein the user information includes attribute information representing an attribute of the user,
the information generation method comprising
generating the activity plan information including the target information corresponding to the attribute information based on the area information and the activity place information.

4. The information generation method according to claim 3, wherein the attribute information includes preference information representing preference of the user,
the information generation method comprising
generating the activity plan information including the target information corresponding to the preference information based on the area information and the activity place information.

5. The information generation method according to claim 1, wherein the user information includes activity status information representing a status at time of activity of the user,
the information generation method comprising
generating the activity plan information including the target information corresponding to the activity status information based on the area information and the activity place information.

6. The information generation method according to claim 1, wherein the area information further includes environment information representing an environment in the predetermined area,
the information generation method comprising
generating the activity plan information including the target information corresponding to the user information and the environment information based on the area information and the activity place information.

7. The information generation method according to claim 1, wherein the target information further includes information representing a status of the target corresponding to the target information,
the information generation method comprising
generating the activity plan information including the target information corresponding to the user information based on the area information and the activity place information.

8. The information generation method according to claim 1, wherein the activity place information includes time at which the user should be located in the activity place,
the information generation method comprising
generating the activity plan information including the target information representing the target in which the user can act based on the area information and the activity place information.

9. The information generation method according to claim 8, wherein the activity place information includes time to be located in a preset departure place and time to be located in a preset arrival place, the departure place and the arrival place being the activity places of the user,
the information generation method comprising
generating, based on the area information and the activity place information, the activity plan information including the target information representing the target that allows the user to depart from the departure place at the time to be located in the departure place and arrive at the arrival place at the time to be located at the arrival place and allows the user to act during time between when the user departs from the departure place and when the user arrives at the arrival place.

10. The information generation method according to claim 8, comprising
generating the activity plan information including the target information representing the target in which the user can stay for a preset duration or more based on the area information and the activity place information.

11. The information generation method according to claim 1, comprising
presenting the target information to the user and also receiving selection of the target information from the user, and generating the activity plan information including the selected target information.

12. The information generation method according to claim 1, comprising
generating the activity plan information including time at which the user should be located in the activity place and time at which the user acts in the target corresponding to the target information.

13. An information generation system comprising:
at least one memory configured to store instructions; and
at least one processor configured to execute the instructions to:
acquire activity place information representing a preset activity place of a user and user information representing a characteristic of the user; and
generate, based on area information including target information representing an activity target which can be a target for an activity by the user in a predetermined area and based on the activity place information and the user information, activity plan information representing a new activity plan of the user including the target information corresponding to the user information.

14. The information generation system according to claim 13, wherein:
the target information includes information of a preset visit place and/or traveling unit in the predetermined area; and
the at least one processor is configured to generate the activity plan information including the information of the visit place and/or traveling unit corresponding to the user information based on the area information and the activity place information.

15. The information generation system according to claim 13, wherein:
the user information includes attribute information representing an attribute of the user; and
the at least one processor is configured to generate the activity plan information including the target information corresponding to the attribute information based on the area information and the activity place information.

16. (canceled)

17. The information generation system according to claim 13, wherein:
the user information includes activity status information representing a status at time of activity of the user; and
the at least one processor is configured to generate the activity plan information including the target information corresponding to the activity status information based on the area information and the activity place information.

18. The information generation system according to claim 13, wherein:
the area information further includes environment information representing an environment in the predetermined area; and
the at least one processor is configured to generate the activity plan information including the target information corresponding to the user information and the environment information based on the area information and the activity place information.

19. The information generation system according to claim 13, wherein:
the target information further includes information representing a status of the target corresponding to the target information; and
the at least one processor is configured to generate the activity plan information including the target information corresponding to the user information based on the area information and the activity place information.

20. The information generation system according to claim 13, wherein:
the activity place information includes time at which the user should be located in the activity place; and
the at least one processor is configured to generate the activity plan information including the target information representing the target in which the user can act based on the area information and the activity place information.

21. (canceled)

25. A non-transitory computer-readable storage medium having a computer program stored therein, the computer program comprising instructions for causing an information processing apparatus to execute instructions to:
acquire activity place information representing a preset activity place of a user and user information representing a characteristic of the user; and
generate, based on area information including target information representing an activity target which can be a target for an activity by the user in a predetermined area and based on the activity place information and the user information, activity plan information representing a new activity plan of the user including the target information corresponding to the user information.
